(19) United States
(12) Patent Application Publication
(10) Pub. No.: US 2007/0228331 A1
(43) Pub. Date: Oct. 4, 2007

(54) Q silicone-containing composition, optoelectronic encapsulant thereof and device thereof

(76) Inventors: Deborah Ann Haitko, Schenectady, NY (US); John T. Leman, Niskayuna, NY (US)

Correspondence Address: Scott A. McCollister;Fay, Sharpe, Fagan, Minnich & McKee, LLP, Seventh Floor, 1100 Superior Avenue, Cleveland, OH, 44114-2579, US

(21) Appl. No.: 11/391,021

(22) Filed: Mar. 28, 2006

(51) Int. Cl. H05B 33/00; H05B 33/04; C09K 11/02

(52) U.S. Cl. 252/301.36; 313/512

(57) ABSTRACT

The invention provides a composition comprising a phosphor and a Q-containing silicone; an encapsulant formulation comprising a phosphor and a Q-containing silicone; and a device including an optoelectronic device such as LED, a phosphor, and a Q-containing silicone. The Q-containing silicone passes thermal shock condition of up to 150° C., and has many suitable properties such as transparency and viscosity to function as a phosphor binder.

### BACKGROUND OF THE INVENTION

This invention is generally related to a composition comprising a phosphor and a Q-containing silicone, an encapsulant formulation comprising a phosphor and a Q-containing silicone, and an optoelectronic device such as LED including an encapsulant that is made from the formulation comprising a phosphor and a Q-containing silicone.

How to strongly adhere phosphor into and/or onto a substrate remains a technical challenge. For example, current silicone materials used as phosphor binders pose problems in terms of adhesion and exposure to thermal shock conditions. To address this problem, commercial silicones that contain fillers or adhesive promoters have to be used.

Moreover, United States Patent Application 20030122477 has disclosed binders to hold powder phosphor particles together as well as to the glass screen of a field emission display device, and to prevent shedding of phosphor material. According to the publication, the binder material is selected from Group A including potassium silicate, ammonium silicate, tin(II) 2-ethylhexanoate, tin (IV) isopropoxide, tin (II) oxalate, titanium (IV) ethoxide, zinc 2,4-pentane dionate, zinc acetate, zinc oxalate indium oxalate, and cadmium oxalate; or from Group B including polyvinyl alcohol, poly(propylene carbonate), poly(propylene carbonate) and poly(ethylene Carbonate) etc.

United States Patent Application 20040173807 filed by Tian et al. has disclosed application of cerium-doped garnet phosphors to semiconductor LED chips for manufacturing lighting devices. The phosphors are applied to the LED by forming a phosphor slurry with a polymerizable material such as polyvinyl alcohol in a solution, coating the exposed surface of the LED with the slurry, and polymerizing the polymerizable material thermally or photochemically.

United States Patent Application 20010048966 filed by Trumble et al. has taught a luminescent binder comprising SiO₂ nanoparticles doped with terbium or terbium and yttrium. The binder promotes adherence of phosphor coatings to lamp envelopes and emits visible light under UV and VUV excitation.

Advantageously, the present invention offers a composition comprising a phosphor and a Q-containing silicone; an encapsulant formulation comprising a phosphor and a Q-containing silicone; and a device including an optoelectronic device such as LED, a phosphor, and a Q-containing silicone. The Q-containing silicone passes thermal shock condition of up to 150° C., and has many suitable properties such as viscosity to function as a phosphor binder.

### BRIEF DESCRIPTION OF THE INVENTION

One aspect of the invention provides a composition comprising a phosphor and a Q-containing silicone. The Q-containing silicone passes thermal shock condition of up to 150° C., and has many suitable properties such as viscosity to function as a phosphor binder.

Another aspect of the invention provides an encapsulant formulation comprising a phosphor and a Q-containing silicone.

Still another aspect of the invention provides a device including an optoelectronic device such as LED, a phosphor, and a Q-containing silicone.

### BRIEF DESCRIPTION OF THE DRAWINGS

FIG. 1 shows thermal aging profiles for three Q-containing silicone samples in an embodiment of the invention;

FIG. 2 shows light transmission spectra of a Q-containing silicone at 0 hour and 17 hours after curing in an embodiment of the invention;

FIG. 3 shows light transmission spectra of another Q-containing silicone at 0 hour and 17 hours after curing in an embodiment of the invention;

FIG. 4 shows light transmission spectra of still another Q-containing silicone at 0 hour and 17 hours after curing in an embodiment of the invention;

FIG. 5 shows a schematic diagram of a LED device according to an embodiment of the present invention;

FIG. 6 shows a schematic diagram of a LED array on a substrate according to one embodiment of the present invention;

FIG. 7 shows a schematic diagram of a LED device according to another embodiment of the present invention; and

FIG. 8 shows a schematic diagram of a vertical cavity surface emitting laser device according to still another embodiment of the present invention.

### DETAILED DESCRIPTION OF THE INVENTION

It is to be understood herein, that if a “range” or “group” is mentioned with respect to a particular characteristic of the present invention, for example, Q % value, viscosity, substitute species, and temperature etc., it relates to and explicitly incorporates herein each and every specific member and combination of sub-ranges or sub-groups therein whatsoever. Thus, any specified range or group is to be understood as a shorthand way of referring to each and every member of a range or group individually as well as each and every possible sub-range or sub-group encompassed therein; and similarly with respect to any sub-ranges or sub-groups therein.

The present invention provides a composition comprising a phosphor and a Q-containing silicone. In a variety of exemplary embodiments, the Q-containing silicone typically has a Q % value of from 1% to 20%, preferably from 2% to 10%, and more preferably from 5% to 6%. The Q-containing silicone functions as a phosphor binder for the phosphor and may be used to incorporate phosphor materials into various optoelectronic devices such as light emitting diode (LED).

In a variety of exemplary embodiments, not only the viscosity of the phosphor binder mixture varies, when cured, from a lower level that is suitable for phosphor inclusion to a higher level that is suitable for robustly binding the phosphor into an optoelectronic device, but also the interpenetrating network generated from the Q resin strengths the integration of the phosphor in the cured composition, enabling endurance against harsh conditions such as thermal shock, temperatures exceeding 125° C., and UV exposure etc.

In an embodiment of the invention, the Q-containing silicone can be cured to contain sufficient viscosity for phosphor inclusion. When exposed to, for example, thermal shock conditions of up to 150° C., the Q-containing silicone formulation can maintain structural integrity, and show a stable and prolonged transmission capability for a wide spectrum of light, such as 350 nm-750 nm.

Various advantages of the Q-containing silicone include, for example, availability, ease in handling, sufficient viscosity, and passing thermal shock. Without being bond by any theory, it is believed that interpenetrating network of the Q-containing silicone resin is at least partially responsible for the advantages of the Q-containing silicone.

According to the present invention, Q % value of the Q-containing silicone is defined based on the “MDTQ” shorthand nomenclature system for silicone materials and silicone resins. The four units under the nomenclature, Q, T, D, and M, are defined respectively as shown below.

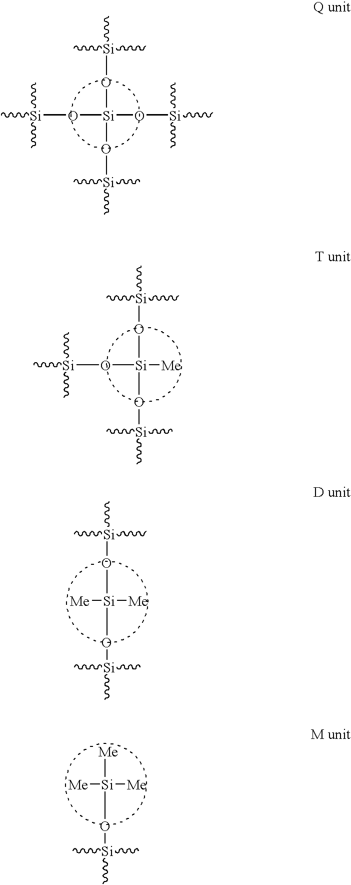

A prime on the unit symbols, for example, M′, D′, T′, and Q′, denote substituents other than the methyl group (Me) as shown above. For example, M^{vi} and D^{Ph} denote that the methyl groups in the above M and D units have been replaced by vinyl (Vi) or phenyl (Ph) group.

According to the present invention, the percentage of Q units, Q %, in a given silicone sample is calculated by the following equation:
Q %=N_{Q}/(N_{M}+N_{D}+N_{T}+N_{Q})×100%
in which N_{M}, N_{D}, N_{T}, and N_{Q} are respectively the total moles or number of M and any M′; D and any D′; T and any T′; and Q and any Q′ units in the silicone sample.

In a variety of exemplary embodiments, the Q-containing silicone is an aliphatic silicone, and contains minimal or no aromatic groups such as phenyl group.

An ethylene bond (—CH₂CH₂—) between two silicone atoms may be formed by a hydrosilylation reaction as shown below.

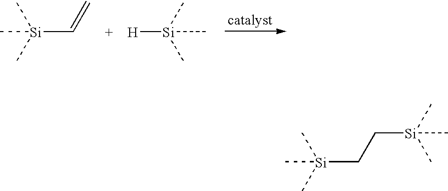

In a variety of exemplary embodiments, the hydrosilylation reaction may be carried out to prepare the Q-containing silicone of the invention, in the presence of a hydrosilylation catalyst selected from the group of ruthenium, osmium, rhodium, iridium, palladium and platinum hydrosilylation catalysts. Exemplary of such catalysts are those described in U.S. Pat. Nos. 2,823,218; 3,159,601; 3,159,662; and 3,775,452. Preferably, the catalysts are platinum catalysts such as platinum black, platinum chloride, chloroplatinic acid, the reaction products of chloroplatinic acid with monohydric alcohols, complexes of chloroplatinic acid with olefins, platinum bisacetoacetate, and other solubilized platinum compounds. A skilled person in the art may consult numerous prior patents and references on the usage of platinum catalyst. For example, platinum compounds having the formula (PtCl₂Olefin) and H(PtCl₃Olefin) are described in U.S. Pat. No. 3,159,601; cyclopropane complex of platinum chloride is described in U.S. Pat. No. 3,159,662; a complex formed from chloroplatinic acid with up to 2 moles per gram of platinum of a member selected from the class consisting of alcohols, ethers, aldehydes and mixtures of the above is described in U.S. Pat. No. 3,220,972. Other catalysts are described in U.S. Pat. Nos. 3,715,334; 3,775,452; and 3,814,730 to Karstedt. Additional background concerning the art may be found at J. L. Spier, “Homogeneous Catalysis of Hydrosilation by Transition Metals, in Advances in Organometallic Chemistry, volume 17, pages 407 through 447, F. G. A. Stone and R. West editors, published by the Academic Press (New York, 1979).

In preferred embodiments of the invention, the platinum catalysts are those platinum compound catalysts that are well soluble in the reaction mixture, and optical clarity of the cured composition can be obtained, for example, reaction product of H₂PtCl₆ in n-octanol.

In a variety of exemplary embodiments, the hydrosilylation reaction uses Pt catalyst. The Pt catalyst concentration in the silicone may range from 5 to 20 ppm, preferably from 10 to 15 ppm.

In preferred embodiments of the invention, the preparation of the Q-containing silicone may be accomplished by using various commercially available ingredients. As a merit of the embodiment, the preparation is easy and convenient.

In an embodiment of the present invention, the Q-containing silicone is prepared from room temperature vulcanizing (RTV) silicone systems. RTV silicones usually come as uncured rubbers with liquid or paste-like consistencies, and are used for sealants, mould making, encapsulation and potting. RTV curing is based on chemical reactions that provide cross-linking and increase molecular weights, e.g. hydrosilylation as described above, preferably in the presence of catalysts to ensure cure control.

In preferred embodiments, the Q-containing silicone of the present invention is prepared from a RTV-2 silicone system. The curing of RTV-2 silicones may be triggered by mixing together two separate components (part A and part B), preferably one of which contains a catalyst such as a hydrosilylation catalyst, e.g. Pt catalyst.

In a variety of exemplary embodiments, Part A and part B components of the RTV-2 may be mixed according to desired mix ratio. With clean tools, one may thoroughly mix the ingredients together, scraping the sides and bottom of the container carefully to produce a homogeneous mixture. When using power mixers, an operator should avoid excessive speeds which could entrap large amounts of air, or cause overheating of the mixture, resulting in shorter pot life. Air entrapped during mixing should be removed to eliminate voids in the cured product. The mixed material may be exposed to a vacuum of about 25 mm (29 in.) of mercury. The material will typically expand, crest, and recede to approximately the original level as the bubbles break. Degassing is usually complete approximately two minutes after frothing ceases. For potting, a deaeration step may be necessary after pouring to avoid capturing air in complex assemblies. In some embodiments, automatic equipment designed to meter, mix, deaerate, and dispense the composition of the present invention will add convenience to continuous or large volume operations.

In an embodiment, cure temperature for the RTV silicone is in the range of about 50° C. to about 160° C., preferably in the range of about 80° C. to about 155° C. Cure through time or cure time may be in the range of about 0.1 hours to about 4 hours, preferably in the range of about 0.5 hours to about 3 hours and most preferably in the range of about 1 hour to about 2 hours.

The viscosity of a fluid is its resistance to shear or flow and is a measure of the fluids adhesive/cohesive or frictional properties. The resistance is caused by intermolecular friction exerted when layers of fluids attempts to slide by another. There are many ways to measure viscosity and consequently many ways to express it, for example, CentiStokes (cSt), CentiPoises (cP), Saybolt Universal Seconds (SSU) and degree Engler. A skilled person knows how to convert one viscosity unit to another, for example, CentiPoises (cp)=CentiStokes (cSt)×Density. In typical embodiments of the invention, the RTV silicone may have a viscosity (@25° C., uncured and mixed) in the range of about 3500 to about 4500 cps.

Other properties of the cured RTV silicone may include, for example, a thermal expansion in the range of about 20-35×10⁻⁵ (° C.)⁻¹; a thermal conductivity in the range of about 0.18 to about 0.2 W/m·° K; and any other suitable properties such as brittle point, hardness, tensile strength, elongation, volume resistivity, dielectric strength, and dielectric constant etc.

In a variety of exemplary embodiments, the RTV-2 Q-containing silicone system will normally cure in contact with most clean, dry surfaces such as phosphor particles, LED, and other encapsulating materials such as epoxy resin. However, it should be noted that certain materials, such as butyl and chlorinated rubber, sulfur-containing materials, amines, and certain metal soap-cured RTV silicone rubber compounds, can cause cure inhibition. Cure inhibition is characterized by a gummy appearance of the RTV silicone rubber compound at the interface between it and the substrate.

Preferred specific examples of RTV-2 silicone materials include, but are not limited to, those are known and readily available commercially such as RTV 615 and RTV 656 or 655 from General Electric Silicones.

GE RTV 615 per se is clear and dispensed easily and may be used as silicone rubber compound for electronic potting with optical clarity allowing maximum light transmission, and also protecting electronic components against shock, moisture, and other environmental hazards. RTV 615 comprises polydimethylsiloxane bearing vinyl groups and a platinum catalyst (Part A) and a cross-linker containing silicon hydride (Si—H) groups (Part B) which form a covalent bond with vinyl groups. RTV 615 normally comprises Part A and Part B in a weight ratio of 10:1 (Part A: Part B). More information on GE RTV 615 is available in the following Table 1.

TABLE 1

| | |
|---|---|
| RTV615 | Clear, two part, high strength, pourable, condensation |
| | cure, silicone rubber compound for electronic potting |
| | for optical clarity. Protects electronic components |
| | against shock, moisture, and other environmental |
| | hazards. Allows maximum light transmission. |

| | | | | Method |
|---|---|---|---|---|
| | | | | and |
| Property | Value | | Test | Condition |
| Appearance | Clear | | — | Uncured, |
| | | | | Mixed |
| CHEMISTRY | Addition | | — | — |
| CURE | Room Temperature | | — | — |
| | or Heat | | | |
| Coefficient | 0.00027° | C. cm/cm | Cured 1 hr. | — |
| of | | | @ 100° C. | |
| Expansion | | | (212° F.) | |
| Consistency/ | Flowable | | — | Uncured, |
| Physical | | | | Mixed |
| Form | | | | |
| Density | 1.02 | g/cm\hat{ }3 | — | catalyzed |
| | | | | 10:1 |
| Dielectric | 2.89 | | Cured 1 hr. | — |
| Constant | | | @ 100° C. | |
| | | | (212° F.) | |
| Dielectric | 19.7 | kV/mm | Cured 1 hr. | — |
| Strength | | | @ 100° C. | |
| | | | (212° F.) | |
| Dissipation | 0.0004 | | Cured 1 hr. | — |
| Factor | | | @ 100° C. | |
| | | | (212° F.) | |
| Durometer | 44 | Shore A | Cured 1 hr. | — |
| Hardness | | | @ 100° C. | |
| | | | (212° F.) | |
| Elongation | 160% | | Cured 1 hr. | — |
| | | | @ 100° C. | |
| | | | (212° F.) | |
| Mix Ratio | 10:1 | | — | — |
| Refractive | 1.406 | | Cured 1 hr. | — |
| Index | | | @ 100° C. | |
| | | | (212° F.) | |
| Shrinkage | 0.2% | | Cured 1 hr. | — |
| | | | @ 100° C. | |
| | | | (212° F.) | |
| Specific | 1.25 | J/g · K | Cured 1 hr. | — |
| Heat | | | @ 100° C. | |
| | | | (212° F.) | |
| Tensile | 6.37 | MPa | Cured 1 hr. | — |
| Strength | | | @ 100° C. | |
| | | | (212° F.) | |
| Thermal | 0.19 | W/m deg K | Cured 1 hr. | — |
| Conduc- | | | @ 100° C. | |
| tivity | | | (212° F.) | |
| Viscosity | 4000 | cps | — | Uncured, |
| | | | | Mixed |
| Volume | 1.8E15 | ohm-cm | Cured 1 hr. | — |
| Resis- | | | @ 100° C. | |
| tivity | | | (212° F.) | |
| Work Time | 4 | hours | — | Uncured, |
| | | | | Mixed |

Optionally, a primer may be used when RTV-2 silicone system is applied on a non-silicone substrate. For example, SS4120 primer (RTV 615-1P) may be used with RTV 615, and SS4155 primer may be used with RTV 656. Non-silicone surface may be thoroughly cleaned with a non-oily solvent such as naphtha or methyl ethyl ketone and allow to dry. Then apply a uniform thin film of silicone primer and allow the primer to air dry for one hour or more. Finally, apply freshly catalyzed mixture of RTV-2 to the primed surface and cure as desired.

The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLES

### Example 1

GE RTV 615 Q-containing silicone was prepared. The conditions were mix ratio 1:10, 3×12 s in mixer; 17.5 g, 60 mm mold, degas, cure; cure at 85° C. for 1 hour and at 1500 for 1 hour. Advance thermal age at 150 C.°. Formation of clean elastic disks has been observed.

### Example 2

GE RTV 615 Q-containing silicone was prepared. The conditions were mix ratio 1:10, 3×12 s in mixer; 17.5 g, 60 mm mold, degas, cure; Cure at 150° for 1 hour; and advance thermal age at 150 C.°. Formation of clean elastic disks has been observed.

### Example 3

GE RTV 615 Q-containing silicone was prepared. The conditions were mix ratio 1:10, 3×12 s in mixer; 17.5 g, 60 mm mold, degas, cure; Cure at 150° for 2 hour; and advance thermal age at 150 C.°. Formation of clean elastic disks has been observed.

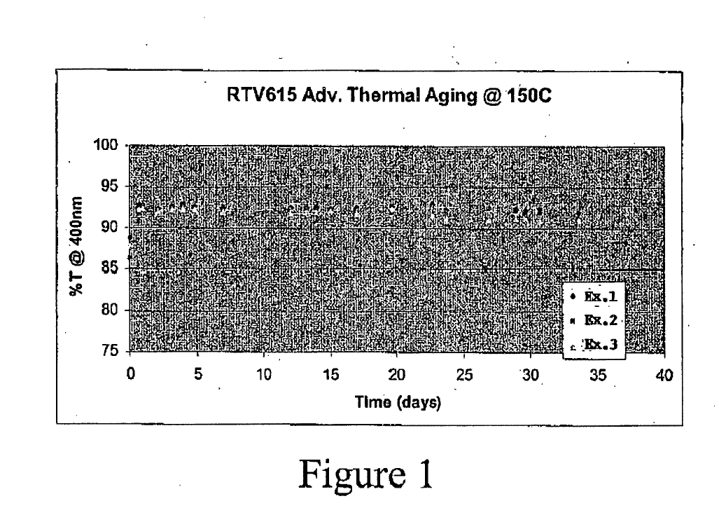

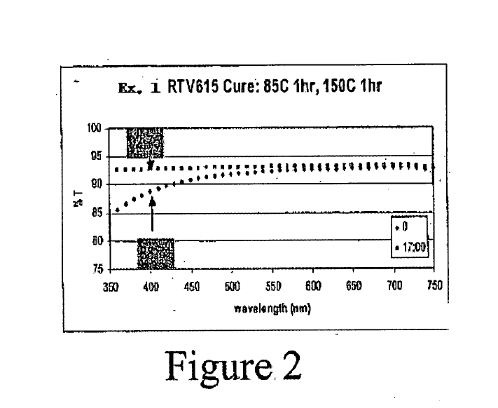

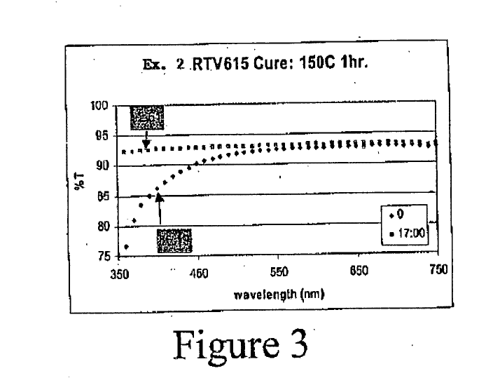

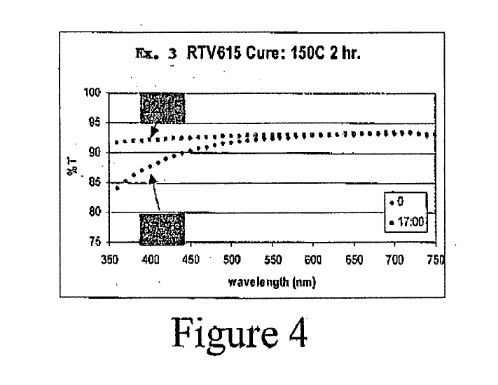

FIG. 1 shows thermal aging profiles for the Q-containing silicones from Examples 1, 2 and 3. The transmission percentage (T %) was measured at 400 nm. FIG. 2 shows light transmission spectra of the Q-containing silicone from Example 1 at 0 hour and 17 hours after curing. FIG. 3 shows light transmission spectra of the Q-containing silicone from Example 2 at 0 hour and 17 hours after curing. FIG. 4 shows light transmission spectra of the Q-containing silicone from Example 3 at 0 hour and 17 hours after curing. As shown in the figures, at the first 17 hours of aging, a slight possible photobleaching in all the Q-containing silicone samples has been observed, after which the transmission leveled off.

In an embodiment, the composition of the invention passes accelerated thermal aging greater than or equal to 150° C. and simultaneous UV exposure greater than or equal to 300 milliwatts at 400 nm.

The present invention provides a composition comprising a phosphor and a Q-containing silicone. There is no specific limitation imposed on the selection of the phosphor. For example, if a LED white light device is to be made, one can use a UV light emitting LED combined with blue, green and red-emitting phosphors; or use a blue LED with a yellow phosphor; or use a blue LED with combined red and green emitting phosphors.

An exemplary phosphor is the cerium-doped yittrium aluminum oxide Y₃Al₅O₁₂ garnet (“YAG:Ce”). Other suitable phosphor examples are based on YAG doped with more than one type of rare earth ions, such as (Y_{1-x-y}GdₓCe_{y})₃Al₅O₁₂ (“YAG:Gd, Ce”), (Y₁₋ₓCeₓ)₃(Al_{5-y}Ga_{y})O₁₂ (“YAG:Ga, Ce”), (Y_{1-x-y}GdₓCe_{y})(Al_{5-z}Ga_{z})O₁₂ (“YAG:Gd,Ga,Ce”), and (Gd₁₋ₓCeₓ)Sc₂Al₃O₁₂ (“GSAG”), where 0≦x≦1, 0≦y≦1, 0≦z≦5, and x+y≦1. For example, the YAG:Gd, Ce phosphor shows an absorption of light in the wavelength range from about 390 nm to about 530 nm (i.e., the blue-green spectral region) and an emission of light in the wavelength range from about 490 nm to about 700 nm (i.e., the green-to-red spectral region). Related phosphors include Lu₃Al₅O₁₂ and Tb₂Al₅O₁₂, both doped with cerium. In addition, these cerium-doped garnet phosphors may also be additionally doped with small amounts of Pr (such as about 0.1-2 mole percent) to produce an additional enhancement of red emission. Non-limiting examples of phosphors that are efficiently excited by radiation of 300 nm to about 500 nm include green-emitting phosphors such as Ca₈Mg(SiO₄)₄Cl₂:Eu²⁺, Mn²⁺; GdBO₃:Ce³⁺, Tb³⁺; CeMgAl₁₁O₁₉:Tb³⁺; Y₂SiO₅:Ce³⁺, Tb³⁺; and BaMg₂Al₁₆O₂₇:Eu²⁺, Mn²⁺ etc.; red-emitting phosphors such as Y₂O₃:Bi³⁺,Eu³⁺; Sr₂P₂O₇:Eu²⁺, Mn²⁺; SrMgP₂O₇:Eu²⁺,Mn²⁺; (Y,Gd)(V,B)O₄:Eu³⁺; and 3.5MgO.0.5MgF₂.GeO₂:Mn⁴⁺ (magnesium fluorogermanate) etc.; blue-emitting phosphors such as BaMg₂Al₁₆O₂₇:Eu²⁺; Sr₅(PO₄)₁₀Cl₂:Eu²⁺; (Ba,Ca,Sr)(PO₄)₁₀(Cl,F)₂:Eu²⁺; and (Ca,Ba,Sr)(Al,Ga)₂S₄:Eu²⁺ etc.; and yellow-emitting phosphors such as (Ba,Ca,Sr)(PO₄)₁₀(Cl,F)₂:Eu²⁺,Mn²⁺ etc. Still other ions may be incorporated into the phosphor to transfer energy from the emitted light to other activator ions in the phosphor host lattice as a way to increase the energy utilization. For example, when Sb³⁺ and Mn²⁺ ions exist in the same phosphor lattice, Sb³⁺ efficiently absorbs light in the blue region, which is not absorbed very efficiently by Mn²⁺, and transfers the energy to Mn²⁺ ion. Thus, a larger total amount of light from light emitting diode is absorbed by both ions, resulting in higher quantum efficiency.

The phosphor used in the invention may take the form of powder or particles. Phosphor particles may be prepared from larger pieces of phosphor material by any grinding or pulverization method, such as ball milling using zirconia-toughened balls or jet milling. They also may be prepared by crystal growth from solution, and their size may be controlled by terminating the crystal growth at an appropriate time. Typically, the phosphor particles have a size in the range of from 1 to 5 μm in diameter.

Optional components may be added to the composition of the invention, for example, fire resistant properties can be improved by the addition flame retardant additives such as platinum compounds, carbon black, aluminium trihydrate, zinc or ceric compounds. It should be noted that carbon black addition also increases electrical conductivity. Ferric oxide may also be added to improve heat stability, titanium dioxide and other organometallic compounds as pigments.

The present invention further provides an encapsulant formulation for optoelectronic device such as LED, which comprises a phosphor and a Q-containing silicone. The Q-containing silicone typically has a Q % value of from 1% to 20%, preferably from 2% to 10%, and more preferably from 5% to 6%. The encapsulant formulation may optionally comprise other ingredients such as epoxy resin, silicone, stabilizer such as thermal stabilizer and UV-stabilizer, cure modifier, refractive index modifier, flame retardant, mold releasing additives, anti-oxidant, and plasticizing additive etc.

An encapsulant made from the formulation of the invention may be used as part of a so-called “LED package”, which is the optical, electrical and/or mechanical support apparatus associated with a LED. Typically, such a package includes systems to provide thermal stability, mechanical stability, photon frequency conversion, optical focusing, electrical connection, thermal management, and so on.

The encapsulant of the present invention can be prepared by combining the various formulation components, and optional components if desired, in any convenient order. In various embodiments, all the components may be mixed together. In other embodiments, two or more components may be premixed and then subsequently combined with other components.

The encapsulant formulation of the present invention may be by hand mixed but also can be mixed by standard mixing equipment such as dough mixers, chain can mixers, planetary mixers, and the like. The blending can be performed in batch, continuous, or semi-continuous mode.

The present invention also provides a device including an optoelectronic device, a phosphor, and a Q-containing silicone. The Q-containing silicone typically has a Q % value of from 1% to 20%, preferably from 2% to 10%, and more preferably from 5% to 6%.

As a skilled person in the art knows, optoelectronics is the branch of electronics that deals with solid-state and other electronic device for generating, modulating, transmitting, and sensing electromagnetic radiation in the ultraviolet, visible, and infrared portions of the spectrum. Optoelectronic device, sometimes referred to as semiconductor device or solid state device includes, but are not limited to, light emitting diodes (LEDs), charge coupled devices (CCDs), photodiodes, vertical cavity surface emitting lasers (VCSELs), phototransistors, photocouplers, optoelectronic couplers, and the like.

Encapsulation techniques for optoelectronic devices comprise casting, resin transfer molding and the like. After the device is enveloped in the uncured encapsulant formulation, typically performed in a mold, the formulation is cured. The curing may be conducted in one or more stages using methods such as thermal, UV, electron beam techniques, or combinations thereof.

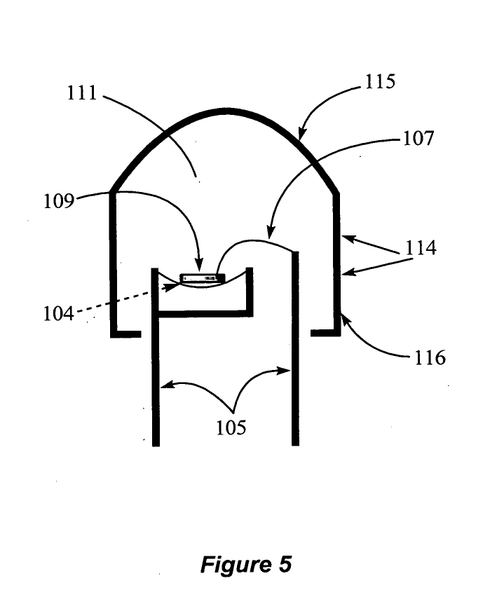

With reference to FIG. 5, the figure schematically illustrates a device according to one embodiment of the present invention. The device contains a LED chip 104, which is electrically connected to a lead frame 105. For example, the LED chip 104 may be directly electrically connected to an anode or cathode electrode of the lead frame 105 and connected by a lead 107 to the opposite cathode or anode electrode of the lead frame 105, as illustrated in FIG. 5. In a particular embodiment illustrated in FIG. 5, the lead frame 105 supports the LED chip 104. However, the lead 107 may be omitted, and the LED chip 104 may straddle both electrodes of the lead frame 105 with the bottom of the LED chip 104 containing the contact layers, which contact both the anode and cathode electrode of the lead frame 105. The lead frame 105 connects to a power supply, such as a current or voltage source or to another circuit (not shown).

The LED chip 104 emits radiation from the radiation emitting surface 109. The LED may emit visible, ultraviolet or infrared radiation. The LED chip 104 may comprise any LED chip 104 containing a p-n junction of any semiconductor layers capable of emitting the desired radiation. For example, the LED chip 104 may contain any desired Group III-V compound semiconductor layers, such as GaAs, GaAlAs, GaN, InGaN, GaP, etc., or Group II-VI compound semiconductor layers such as ZnSe, ZnSSe, CdTe, etc., or Group IV-IV semiconductor layers, such as SiC. The LED chip 104 may also contain other layers, such as cladding layers, waveguide layers and contact layers.

The LED is packaged with an encapsulant 111 prepared according to the present invention. In one embodiment, the LED packaging includes encapsulant 111 located in a package, such as a shell 114. The shell 114 may be any plastic or other material, such as polycarbonate, which is transparent to the LED radiation. However, the shell 114 may be omitted to simplify processing if encapsulant 111 has sufficient toughness and rigidity to be used without a shell 114. Thus, the outer surface of encapsulant 111 would act in some embodiments as a shell 114 or package. The shell 114 contains a light or radiation emitting surface 115 above the LED chip 104 and a non-emitting surface 116 adjacent to the lead frame 105. The radiation emitting surface 115 may be curved to act as a lens and/or may be colored to act as a filter. In various embodiments the non-emitting surface 116 may be opaque to the LED radiation, and may be made of opaque materials such as metal. The shell 114 may also contain a reflector around the LED chip 104, or other components, such as resistors, etc., if desired.

According to the present invention, a phosphor may be interspersed or mixed as a phosphor powder with encapsulant 111 or coated as a thin film on the LED chip 104 or coated on the inner surface of the shell 114. As described supra, any phosphor material may be used with the LED chip. For example, a yellow emitting cerium doped yttrium aluminum garnet phosphor (YAG:Ce³⁺) may be used with a blue emitting InGaN active layer LED chip to produce a visible yellow and blue light output which appears white to a human observer. Other combinations of LED chips and phosphors may be used as desired. A detailed disclosure of a UV/blue LED-Phosphor Device with efficient conversion of UV/blue Light to visible light may be found in U.S. Pat. No. 5,813,752 (Singer) and U.S. Pat. No. 5,813,753 (Vriens).

While the packaged LED chip 104 is supported by the lead frame 105 according to one embodiment as illustrated in FIG. 5, the LED can have various other structures. For example, the LED chip 104 may be supported by the bottom surface 116 of the shell 114 or by a pedestal (not shown) located on the bottom of the shell 114 instead of by the lead frame 105.

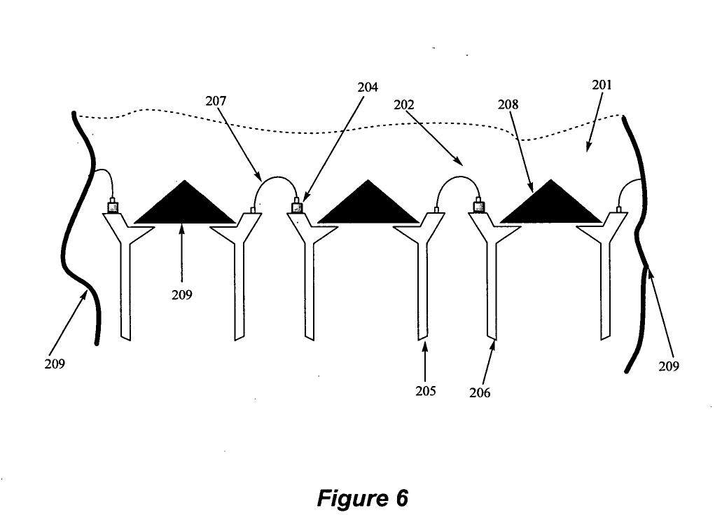

A device including a LED array fabricated on a plastic substrate is illustrated in FIG. 6. With reference to FIG. 6, the LED chips or die 204 are physically and electrically mounted on cathode leads 206. The top surfaces of the LED chips 204 are electrically connected to anode leads 205 with lead wires 207. The lead wires may be attached by known wire bonding techniques to a conductive chip pad. The leads 206, 205 comprise a lead frame and may be made of a metal, such as silver plated copper. The lead frame and LED chip array are contained in a plastic package 209, such as, for example, a polycarbonate package, a polyvinyl chloride package or a polyetherimide package. In some embodiments the polycarbonate comprises a bisphenol A polycarbonate. The plastic package 209 is filled with an encapsulant 201 of formulation according to the present invention. The package 209 contains tapered interior sidewalls 208, which enclose the LED chips 204, and form a light spreading cavity 202, which ensures cross fluxing of LED light.

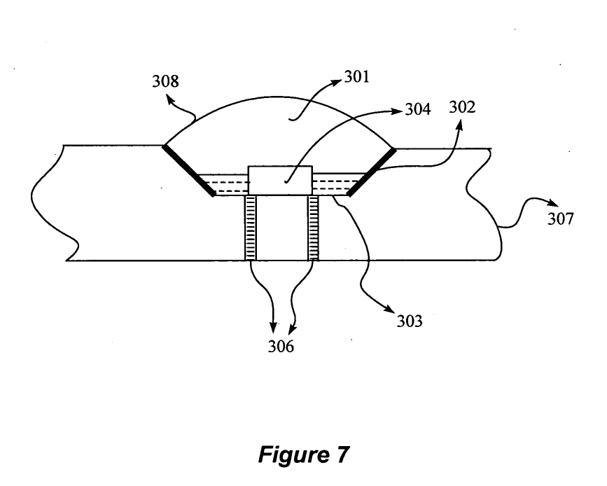

FIG. 7 shows a device in which the LED chip 304 is supported by a carrier substrate 307. With reference to FIG. 7, the carrier substrate 307 comprises a lower portion of the LED package, and may comprise any material, such as plastic, metal or ceramic. Preferably, the carrier substrate is made out of plastic and contains a groove 303 in which the LED chip 304 is located. The sides of the groove 303 may be coated with a reflective metal 302, such as aluminum, which acts as a reflector. However, the LED chip 304 may be formed over a flat surface of the substrate 307. The substrate 307 contains electrodes 306 that electrically contact the contact layers of the LED chip 304. Alternatively, the electrodes 306 may be electrically connected to the LED chip 304 with one or two leads as illustrated in FIG. 7. If desired, the shell 308 or a glass plate may be formed over the encapsulant 301 to act as a lens or protective material.

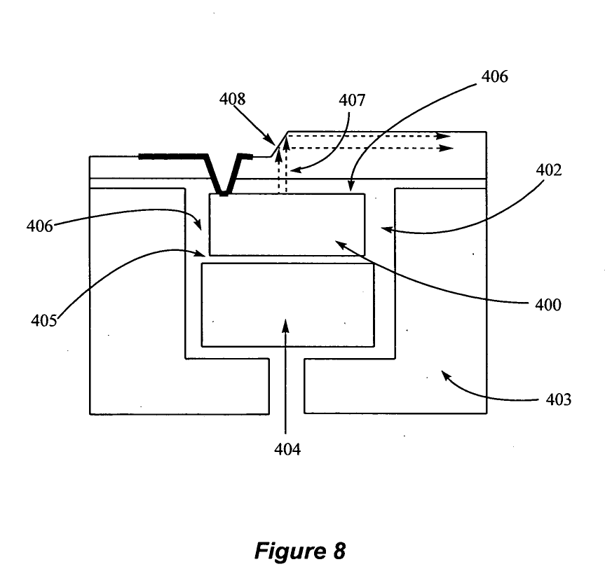

A vertical cavity surface emitting laser (VCSEL) is illustrated in FIG. 8. With reference to FIG. 8, the VCSEL 400 may be embedded inside a pocket 402 of a printed circuit board assembly 403. A heat sink 404 maybe placed in the pocket 402 of the printed circuit board 403 and the VCSEL 400 may rest on the heat sink 404. The encapsulant 406 of the present inventive formulation may be injected into the cavity 405 of the pocket 402 in the printed circuit board 403 and may flow around the VCSEL and encapsulate it on all sides and also form a coating top film 406 on the surface of the VCSEL 400. The top coating film 406 protects the VCSEL 400 from damage and degradation and at the same time is inert to moisture and is transparent and polishable. The laser beams 407 emitting from the VCSEL may strike the mirrors 408 to be reflected out of the pocket 402 of the printed circuit board 403.

It should be understood that the Q-containing silicone can also be used with non-light emitting chips and electronic components, for example, logic and memory devices, such as microprocessors, ASICs, DRAMs and SRAMs, as well as electronic components, such as capacitors, inductors and resistors.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and publications cited herein are incorporated herein by reference.

1. A composition, which comprises a phosphor and a Q-containing silicone.

2. The composition according to claim 1, in which the Q-containing silicone has a Q % value of from 1% to 20%.

3. The composition according to claim 1, in which the Q-containing silicone has a Q % value of from 2% to 10%.

4. The composition according to claim 1, in which the Q-containing silicone has a Q % value of from 5% to 6%.

5. The composition according to claim 1, in which the Q-containing silicone is an aliphatic silicone.

6. The composition according to claim 1, in which the Q-containing silicone is prepared from hydrosilylation reaction.

7. The composition according to claim 6, in which the hydrosilylation reaction uses Pt catalyst.

8. The composition according to claim 7, in which the Pt catalyst concentration is from 5 to 20 ppm.

9. The composition according to claim 7, in which the Pt catalyst concentration is from 10 to 15 ppm.

10. The composition according to claim 1, in which the Q-containing silicone comprises a room temperature vulcanizing (RTV) silicone.

11. The composition according to claim 10, in which the RTV silicone is a RTV-2 silicone.

12. The composition according to claim 11, in which the RTV-2 silicone is selected from the group consisting of GE RTV 615, GE RTV 656, and GE RTV 655.

13. The composition according to claim 1, which passes accelerated thermal aging greater than or equal to 150° C. and simultaneous UV exposure greater than or equal to 300 milliwatts at 400 nm.

14. An encapsulant formulation, which comprises a phosphor and a Q-containing silicone.

15. The encapsulant formulation according to claim 14, in which the Q-containing silicone has a Q % value of from 1% to 20%.

16. The encapsulant formulation according to claim 14, in which the Q-containing silicone has a Q % value of from 5% to 6%.

17. The encapsulant formulation according to claim 14, further comprising other ingredient selected from the group consisting of epoxy resin, silicone, stabilizer such as thermal stabilizer and UV-stabilizer, cure modifier, refractive index modifier, flame retardant, mold releasing additives, anti-oxidant, and plasticizing additive.

18. A device, which includes an optoelectronic device, a phosphor, and a Q-containing silicone.

19. The device according to claim 18, in which the optoelectronic device is selected from the group consisting light emitting diode (LED), charge coupled device (CCD), photodiode, vertical cavity surface emitting laser (VCSEL), phototransistor, photocoupler, and optoelectronic coupler.

20. The device according to claim 18, in which the optoelectronic device is LED.
